(19) United States
(12) Patent Application Publication
(10) Pub. No.: US 2013/0177411 A1
(43) Pub. Date: Jul. 11, 2013

(54) SYSTEM AND METHOD FOR SEALING A GAS PATH IN A TURBINE

(71) Applicants: David Wayne Weber, Simpsonville, SC (US); Victor John Morgan, Simpsonville, SC (US)

(72) Inventors: David Wayne Weber, Simpsonville, SC (US); Victor John Morgan, Simpsonville, SC (US)

(73) Assignee: GENERAL ELECTRIC COMPANY, Schenectady, NY (US)

(21) Appl. No.: 13/343,935

(22) Filed: Jan. 5, 2012

(51) Int. Cl. F01D 9/04; B23P 15/00

(52) U.S. Cl. 415/209.3; 29/889.22

(57) ABSTRACT

A system for sealing a gas path in a turbine includes a stator ring segment, a shroud segment adjacent to the stator ring segment, and a first load-bearing surface between the stator ring segment and the shroud segment. A first non-metallic gasket is in contact with the first load-bearing surface between the stator ring segment and the shroud segment. A method for sealing a gas path in a turbine includes placing a non-metallic gasket between any two of a stator ring segment, a shroud segment, and a casing.

### FIELD OF THE INVENTION

The present disclosure generally involves a system and method for sealing a gas path in a turbine.

### BACKGROUND OF THE INVENTION

Turbines are widely used in a variety of aviation, industrial, and power generation applications to perform work. Each turbine generally includes alternating stages of peripherally mounted stator vanes and rotating blades. The stator vanes may be attached to a stationary component such as a casing that surrounds the turbine, and the rotating blades may be attached to a rotor located along an axial centerline of the turbine. A compressed working fluid, such as steam, combustion gases, or air, flows along a gas path through the turbine. The stator vanes accelerate and direct the compressed working fluid onto the subsequent stage of rotating blades to impart motion to the rotating blades, thus turning the rotor and performing work.

Compressed working fluid that leaks around or bypasses the stator vanes or rotating blades reduces the efficiency of the turbine, and various systems and methods have been developed to reduce and/or prevent the compressed working fluid from leaking around the stator vanes or rotating blades. For example, one or more stator segments and/or shroud segments may be installed circumferentially around the stator vanes and/or rotating blades, respectively, to reduce and/or prevent the compressed working fluid from escaping the gas path. In addition, a cooling media may be supplied outside of the gas path to cool the stator segments and/or shroud segments, and compliant seals may be installed between various combinations of the stator segments, shroud segments, and casing to reduce or prevent the cooling media from entering the gas path. However, compliant seals add complexity and cost to the turbine and therefore are not suitable for all locations. As a result, continued improvements in systems and methods for sealing the gas path in a turbine would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for sealing a gas path in a turbine. The system includes a stator ring segment, a shroud segment adjacent to the stator ring segment, and a first load-bearing surface between the stator ring segment and the shroud segment. A first non-metallic gasket is in contact with the first load-bearing surface between the stator ring segment and the shroud segment.

Another embodiment of the present invention is a system for sealing a gas path in a turbine that includes a stator ring segment, a shroud segment adjacent to the stator ring segment, and a casing that circumferentially surrounds at least a portion of the stator ring segment and the shroud segment. A load-bearing surface is between any two of the stator ring segment, the shroud segment, and the casing. A non-metallic gasket is in contact with the load-bearing surface.

The present invention may also include a method for sealing a gas path in a turbine. The method includes placing a non-metallic gasket between any two of a stator ring segment, a shroud segment, and a casing.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified side cross-section view of a portion of a turbine according to one embodiment of the present invention; and

FIG. 2 is an enlarged view of a non-metallic gasket shown in FIG. 1.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system and method for sealing a gas path in a turbine. The gas turbine generally includes alternating stages of stationary vanes and rotating blades, as is known in the art. The system and method includes one or more one or more stator ring segments and shroud segments that circumferentially surround each stage of stator vanes and rotating blades, respectively. A casing may circumferentially surround at least a portion of the stator ring segments and/or shroud segments, and a non-metallic gasket is located between a load-bearing surface between any two of the stator ring segments, the shroud segments, and the casing. In particular embodiments, the non-metallic gasket may include a mica-based material. The non-metallic gasket is less complex than existing compliant seals, and the mica provides an inexpensive material for reducing leakage between adjacent surfaces, thus increasing the cycle efficiency of the turbine. Although exemplary embodiments of the present invention will be described generally in the context of a gas path in a gas turbine, one of ordinary skill in the art will readily appreciate that embodiments of the present invention may be applied to any turbine.

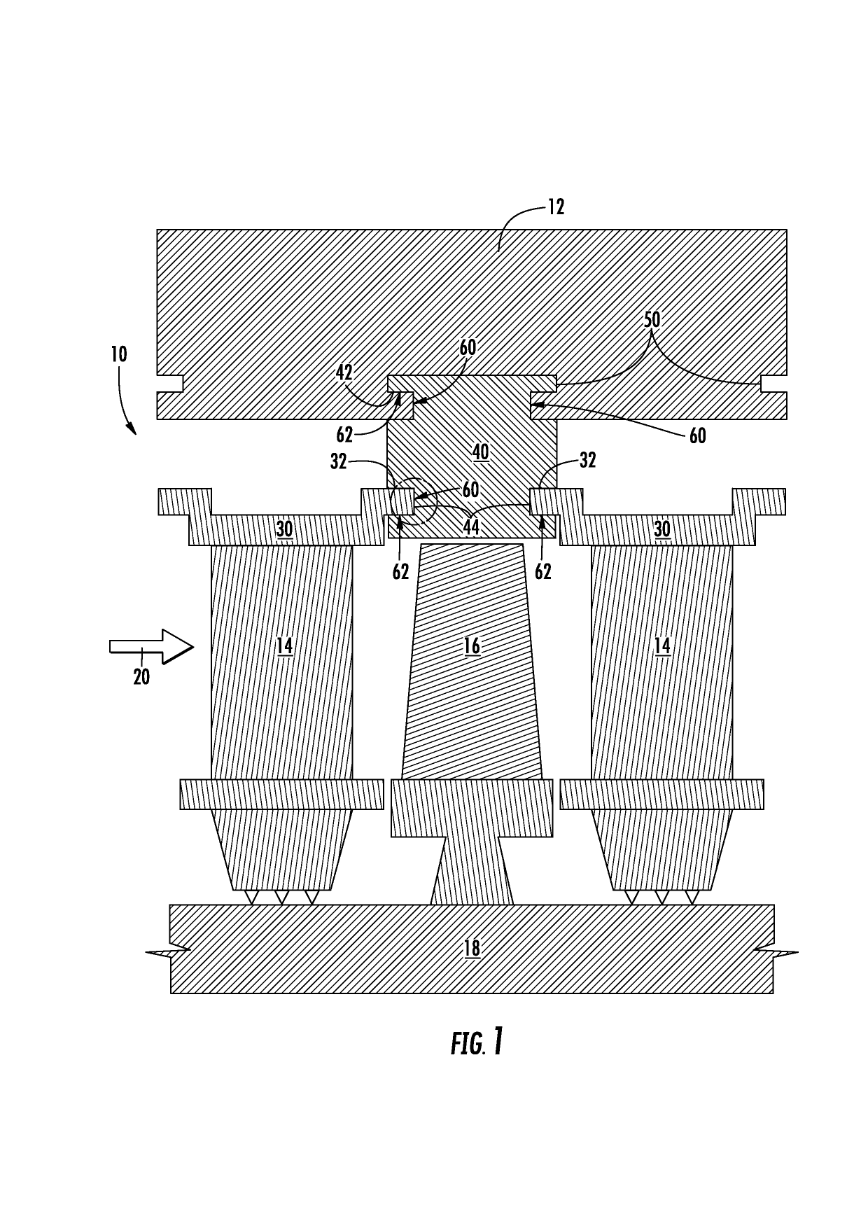

FIG. 1 provides a simplified cross-section view of a portion of a turbine 10 according to one embodiment of the present invention. As shown in FIG. 1, the turbine 10 may include stationary and rotating components surrounded by a casing 12. The stationary components may include, for example, stationary nozzles or stator vanes 14 attached to the casing 12. The rotating components may include, for example, rotating blades 16 attached to a rotor 18. A working fluid 20, such as steam, combustion gases, or air, flows along a hot gas path through the turbine 10 from left to right as shown in FIG. 1. The first stage of stator vanes 14 accelerates and directs the working fluid 20 onto the first stage of rotating blades 16, causing the first stage of rotating blades 16 and rotor 18 to rotate. The working fluid 20 then flows across the second stage of stator vanes 14 which accelerates and redirects the working fluid 20 to the next stage of rotating blades (not shown), and the process repeats for each subsequent stage.

As shown in FIG. 1, the turbine 10 may further include a series of adjacent stator ring segments 30 and shroud segments 40 radially outward from each stage of stator vanes 14 and rotating blades 16, respectively, to reduce the amount of working fluid 20 that bypasses the stator vanes 14 or rotating blades 16. The stator ring segments 30 and shroud segments 40 are typically machined or cast from steel alloys and/or ceramic composites suitable for continuous exposure to the temperatures and pressures anticipated for the working fluid 20. Adjacent stator ring segments 30 form a ring inside the casing 12 that circumferentially surrounds each stage of stator vanes 14, and one or more stator vanes 14 connect to each stator ring segment 30. Adjacent shroud segments 40 similarly form a ring inside the casing 12 that circumferentially surrounds each stage of rotating blades 16.

The casing 12, stator ring segments 30, and shroud segments 40 include complementary surfaces for attaching, connecting, or supporting the various components. For example, as shown in FIG. 1, the casing 12 may include cavities 50, indentions, or slots, and the shroud segments 40 may include complementary shaped hooks 42. In this manner, the hooks 42 on the shroud segments 40 may slide or fit into the cavities 50 in the casing 12 to releasably connect each shroud segment 40 to the casing 12. Similarly, the shroud segments 40 may include cavities 44, indentions, or slots, and the stator ring segments 30 may include complementary shaped hooks 32. In this manner, the hooks 32 on the stator ring segments 30 may slide or fit into the cavities 44 in the shroud segments 40 to releasably connect each stator ring segment 30 to the adjacent shroud segments 40. One of ordinary skill in the art can readily appreciate that alternate structures and arrangements for connecting or attaching the stator ring segments 30 and shroud segments 40 to the casing 12 are within the scope of various embodiments of the present invention. For example, in alternate embodiments, the stator ring segments 30 may be configured to releasably connect to the casing 12, and the shroud segments 40 may be configured to releasably connect to the stator ring segments 30.

The adjacent surfaces between the casing 12, stator ring segments 30, and/or shroud segments 40 create various load-bearing surfaces between these components. For example, as shown in FIG. 1, substantially vertical load-bearing surfaces 60 between the stator ring segment 30 and the shroud segment 40 transfer aerodynamic forces created by the flow of the working fluid 20 across the stator vanes 14. Similarly, substantially horizontal load-bearing surfaces 62 between the stator ring segment 30 and the shroud segment 40 transfer forces created by thermal expansion of various components inside the turbine 10. Specifically, changes in the temperature of the working fluid 20 flowing through the turbine 10 causes the stator vanes 14, rotating blades 16, stator ring segments 30, and shroud segments 40 to expand and contract. The substantially horizontal load-bearing surfaces 62 transfer the forces created by this expansion and contraction between adjacent components.

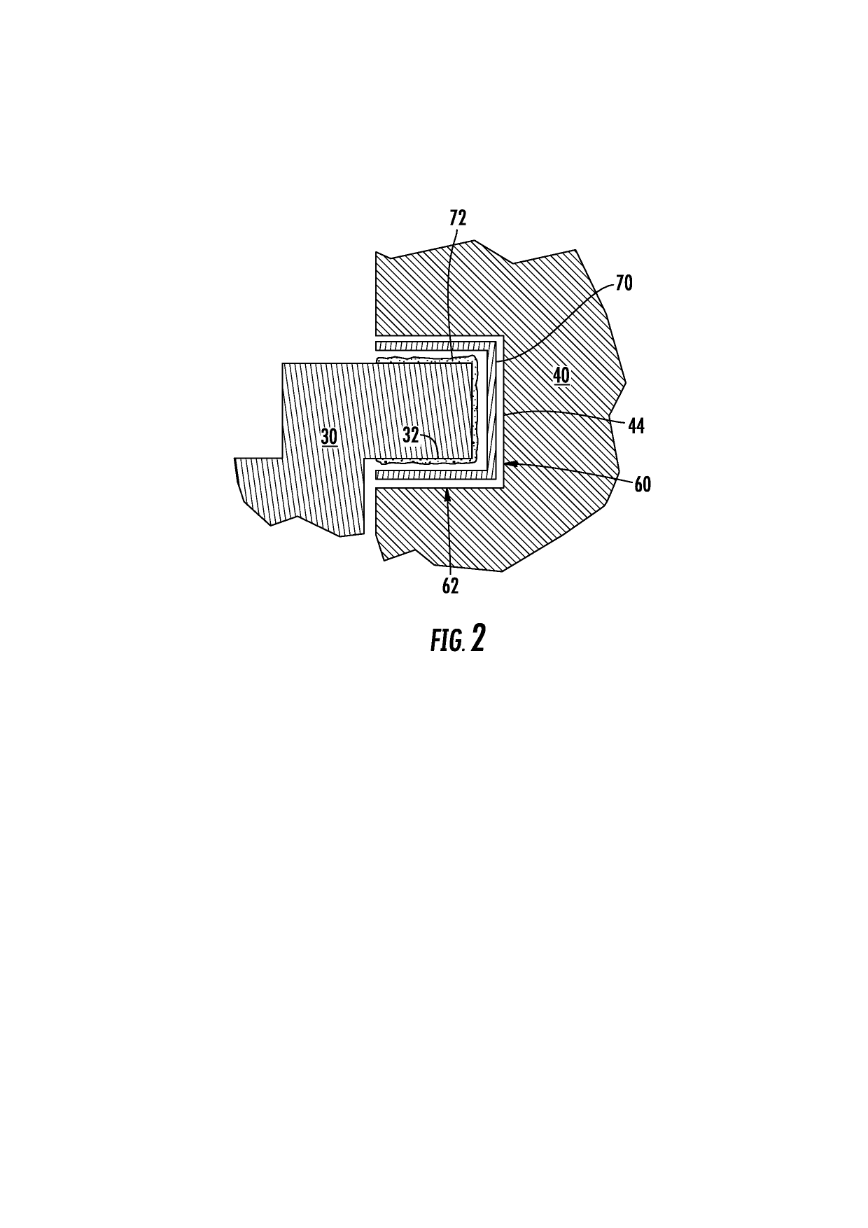

The load-bearing surfaces 60, 62 are generally characterized by adjacent steel alloy or ceramic composite surfaces of the casing 12, stator ring segments 30, and shroud segments 40 that are not well-suited for compliant seals. As a result, non-metallic gaskets 70 may be installed in the load-bearing surfaces 60, 62 to reduce or prevent the cooling media from leaking into the gas path. FIG. 2 provides an enlarged view of the non-metallic gasket 70 shown in FIG. 1 between the stator ring segment 30 and the shroud segment 40. The non-metallic gasket 70 may be inserted between the stator ring segment 30 and shroud segment 40 during assembly, and the load-bearing surfaces 60, 62 may then hold the non-metallic gasket 70 in place. In particular embodiments, the non-metallic gaskets 70 may be attached to one or more of the various surfaces prior to installation in the turbine 10. For example, as shown in FIG. 2, a heat-dissolvable glue 72 or other suitable adhesive may be used to attach the non-metallic gasket 70 to the stator ring segment 30 before sliding the hook 32 of the stator ring segment 30 into the cavity 44 in the shroud segment 40.

The non-metallic gaskets 70 may be manufactured from any material suitable for continuous exposure to the temperatures and pressures anticipated for the working fluid 20. For example, in particular embodiments, the non-metallic gaskets 70 may include mica or the mica group of silicate or phyllosilicate minerals. Mica material is well-suited for the high temperature environment typically present in a gas turbine and is readily formed into thin, smooth, crack resistant sheets that can provide flow resistance between the adjacent surfaces of steel alloys or ceramic composites. The thickness of the non-metallic gasket 70 is typically less than 0.1 inches and may vary according to the particular location. A suitable non-metallic gasket 70 incorporating mica is presently sold by Flexitallic located in Texas under the registered trademark Thermiculite®.

The system described and illustrated with respect to FIGS. 1 and 2 may also provide a method for sealing the gas path in the turbine 10. The method may include placing the non-metallic gasket 70 between any two of the stator ring segment 30, shroud segment 40, and casing 12 to reduce or prevent the cooling media from leaking into the gas path. In particular embodiments, a mica gasket 70 may be placed or installed between any two of the stator ring segment 30, the shroud segment 40, and the casing 12. Alternately or in addition, the method may include attaching the non-metallic gasket 70 to at least one of the stator ring segment 30, the shroud segment 40, or the casing 12.

This written description uses examples to disclose the invention, including the best mode, and also to enable any person skilled in the art to practice the invention, including making and using any systems or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for sealing a gas path in a turbine, comprising:
a. a stator ring segment;
b. a shroud segment adjacent to the stator ring segment;
c. a first load-bearing surface between the stator ring segment and the shroud segment; and
d. a first non-metallic gasket in contact with the first load-bearing surface between the stator ring segment and the shroud segment.

2. The system as in claim 1, wherein the first load-bearing surface is substantially horizontal.

3. The system as in claim 1, wherein the first load-bearing surface comprises a downstream surface of the stator ring segment.

4. The system as in claim 1, wherein the first non-metallic gasket comprises mica.

5. The system as in claim 1, wherein the first non-metallic gasket is attached to at least one of the stator ring segment or the shroud segment.

6. The system as in claim 1, further comprising a casing that circumferentially surrounds at least a portion of the shroud segment, a second load-bearing surface between the shroud segment and the casing, and a second non-metallic gasket in contact with the second load-bearing surface between the shroud segment and the casing.

7. The system as in claim 6, wherein the second non-metallic gasket is attached to at least one of the shroud segment or the casing.

8. A system for sealing a gas path in a turbine, comprising:
a. a stator ring segment;
b. a shroud segment adjacent to the stator ring segment;
c. a casing that circumferentially surrounds at least a portion of the stator ring segment and the shroud segment;
d. a load-bearing surface between any two of the stator ring segment, the shroud segment, and the casing; and
e. a non-metallic gasket in contact with the load-bearing surface.

9. The system as in claim 8, wherein the load-bearing surface is substantially horizontal.

10. The system as in claim 8, wherein the load-bearing surface comprises a downstream surface of the stator ring segment.

11. The system as in claim 8, wherein the load-bearing surface comprises a surface of the casing.

12. The system as in claim 8, wherein the non-metallic gasket comprises mica.

13. The system as in claim 8, wherein the non-metallic gasket is attached to at least one of the stator ring segment, the shroud segment, or the casing.

14. A method for sealing a gas path in a turbine, comprising:
a. placing a non-metallic gasket between any two of a stator ring segment, a shroud segment, and a casing.

15. The method as in claim 14, wherein the placing step comprises placing a mica gasket between any two of the stator ring segment, the shroud segment, and the casing.

16. The method as in claim 14, further comprising placing the non-metallic gasket in a horizontal gap between any two of the stator ring segment, the shroud segment, and the casing.

17. The method as in claim 14, further comprising placing the non-metallic gasket in a load-bearing surface between any two of the stator ring segment, the shroud segment, and the casing.

18. The method as in claim 14, further comprising attaching the non-metallic gasket to at least one of the stator ring segment, the shroud segment, or the casing.
